(19) United States
(12) Patent Application Publication
(10) Pub. No.: US 2013/0166341 A1
(43) Pub. Date: Jun. 27, 2013

(54) SERVICE PROVIDER SELECTION

(71) Applicants: Robert C. Fullington, El Dorado Hills, CA (US); Thomas M. Tripp, Morristown, TN (US)

(72) Inventors: Robert C. Fullington, El Dorado Hills, CA (US); Thomas M. Tripp, Morristown, TN (US)

(73) Assignee: Hewlett-Packard Development Company LP

(21) Appl. No.: 13/335,861

(22) Filed: Dec. 22, 2011

(51) Int. Cl. G06Q 10/06

(52) U.S. Cl. 705/7.14; 705/7.13

(57) ABSTRACT

A population of service providers is filtered to identify candidate service providers. The filtering is based upon whether each server provider has a starting location within a geographic zone containing the service destination. Travel times to the destination for the candidate service providers are compared and used for selecting a service provider from the candidate service providers.

### BACKGROUND

In many circumstances, repair or product delivery services are provided on an emergency or urgent basis. In such circumstances, penalties may be imposed if the service is not completed within a predefined time. Identifying a provider for the service from a large population of potential providers may itself consume too much valuable time, possibly preventing the service from being provided or delivered in time.

### BRIEF DESCRIPTION OF THE DRAWINGS

FIG. 1 is a schematic illustration of an example service provider selection system 20.

FIG. 2 is a flow diagram of an example method that may be carried out by the system of FIG. 1.

FIG. 3 is a diagram of an example geo-zone filter that may be utilized in the method of FIG. 2.

FIG. 4 is a diagram of another example geo-zone filter that may be utilized in the method of FIG. 2.

FIG. 5 is a diagram of another example geo-zone filter that may utilize in the method of FIG. 2.

FIG. 6 is a flow diagram of another example method that may be carried out by the system of FIG. 1.

FIG. 7 is a flow diagram of another example method that may be carried out by the system of FIG. 1.

### DETAILED DESCRIPTION OF THE EXAMPLE EMBODIMENTS

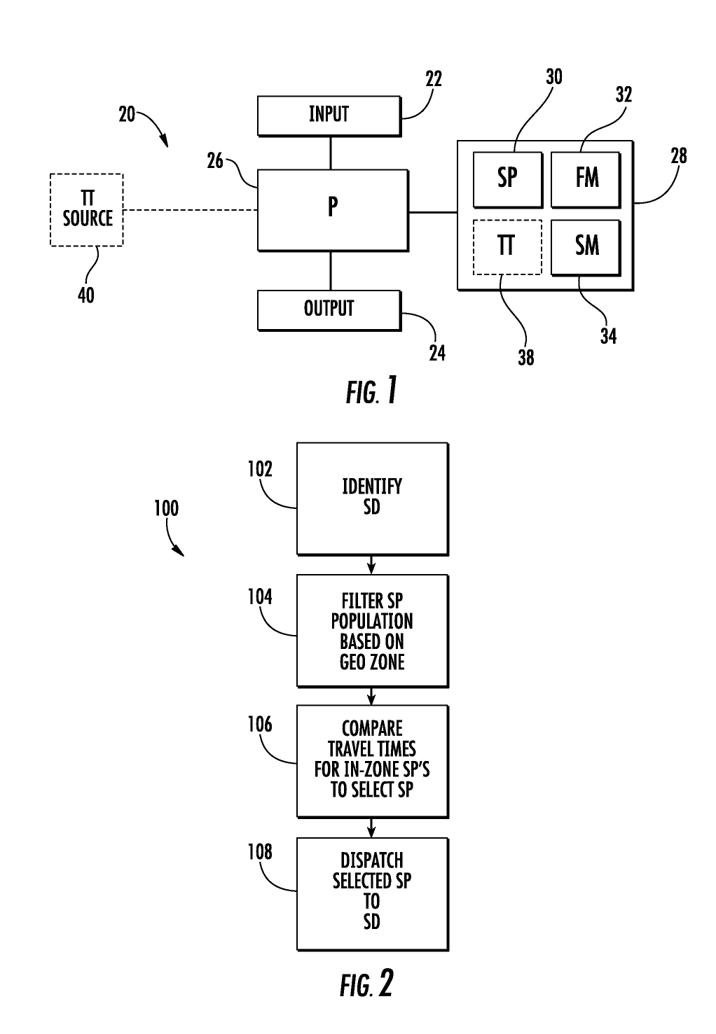

FIG. 1 schematically illustrates an example service provider selection system 20. As will be described hereafter, service provider selection system 20 selects a service provider from a population of service providers for a particular service job at a particular destination in less time. As a result, system 20 enhances the likelihood that services requested on an emergency or urgent basis may be timely provided.

Service provider selection system 20 selects a service provider based upon an identified service destination. For purposes of this disclosure, a service destination is a geographic location to which a service provider must travel for the purpose of completing a service task. In some circumstances, a service task may involve a final endpoint service destination as well as one or more intermediate service destinations. For example, a server task may involve a service provider picking up a part, tool or other information at an intermediate service destination prior to traveling to the final service destination where the part, tool or information will be utilized to complete the service task. For purposes of this disclosure, a service or service task is any job or project wherein a service provider travels to the service destination. For example, a service destination may comprise a geographic location at which a service provider is to deliver a part, a product or other article. A service destination may also comprise a geographic location at which a service provider is to perform a mental and/or physical action such as a repair, inspection, upgrade, prognosis, analysis or other similar services. A service destination may comprise a geographic location at which the service provider is to provide or deliver an article as well as provide a mental or physical action.

In one implementation, the service destination may be identified by prompting the service requester to enter the final service destination or by prompting a service administrator which received the request to input the final service destination. In another implementation, system 20 itself may determine the final service destination using information provided by the service requester. For example, in one implementation, system 20 may include a database of customers who have contracted for service and their addresses. Upon receiving a service request from a customer, system 20 may consult the database and determine the final service destination using the customer's name, phone number from which the request was made or other indicia corresponding to the person or party making the service request.

Service provider selection system 20 comprises input 22, output 24, processor 26 and memory 28. Input 22 comprises one or more devices by which information is received by system 20 facilitating the identification of a service destination (SD). In one implementation, input 22 may comprise a pad, touchpad, a mouse, touch screen, microphone and speech recognition software, pointer and the like. In another implementation, input 22 may comprise a communication interface through which processor 26 receives the final service destination or information that enables identification of the final service destination in a wired or wireless fashion from another source. In another implementation, processor 26 may automatically extract information from the service request itself, such as a phone number from which the service request is received, an Internet ID, user name, or other requester indicia automatically retrievable from a request. Processor 26 uses information and a database linking different destinations to different piece of such information to identify the final service destination of the requester.

Output 24 comprises a device by which the selected service provider is presented for use in dispatching the selected service provider to the final service destination. In one implementation, output 24 may comprise a display screen or monitor which, under the direction of processor 26, displays the selected service provider and associated information, allowing this person to be contacted for assignment to the final service destination. In another implementation, output 24 may comprise an automatic dispatching system, wherein the selected service provider is automatically sent as an electronically generated communication (automated phone message, e-mail, text message or the like) notifying the service provider of the assignment to the final service destination and providing the service provider with any additional information for carrying out the requested service.

Processor 26 comprises one or more processing units configured to receive information from input 22, to select a service provider for an identified final service destination and to output the selected service provider to output 24. For purposes of this application, the term “processing unit” shall mean a presently developed or future developed processing unit that executes sequences of instructions contained in a non-transient computer readable memory, such as memory 28. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, portions of processor 26 and memory 28 may be embodied as part of one or more application-specific integrated circuits (ASICs). Unless otherwise specifically noted, the controller is not limited to any specific combination of hardware circuitry and software, nor to any particular source for the instructions executed by the processing unit.

Memory 28 comprises a non-transient computer-readable medium accessible by processor 26. Memory 28 comprises service provider population database 30, filtering module 32 and selection module 34. Service provider population database 30 comprises a data store, such as a lookup table, containing various information for a population of service providers, including information that may be used to filter the population or cull the total population to a smaller number. Examples of information that may be stored in database 30 include, but are not limited to, service provider certifications (any degrees or training certifications acquired by the service provider, such as a Microsoft Certification), service provider skill levels (what machines, devices, software, etc. for which the service provider has experience or training), service provider languages (what language a service provider is fluent in such as English, Spanish, German, Chinese), service provider security clearances (any security clearances previously obtained from selected clients), service provider availability and service provider location.

Service provider availability may comprise such information as each service provider's working hours or standby hours. Service provider availability may also comprise detailed information regarding the availability of the service provider during a particular day or during particular hours of the day. This information may be updated periodically, such as daily, as non-emergency service assignments are made. For example, on a particular day, a service provider may have service assignments which were previously made prior to the day. This information in database 30 may be consulted to determine whether the service provider is available during a certain time period during the particular day.

Service provider location comprises information pertaining to a geographic location of the service provider from which the service provider must travel to the travel destination. Such a service provider location may comprise a shop, office, dispatch center, service provider permanent residence, or a service provider temporary location (such as a hotel or motel where service provider may be staying). As with service provider availability, this data or information may be updated on a periodic basis, daily or even hourly. For example, during a particular day, a service provider may be at varying distances from the final service destination depending upon the time of day at which servicing at the service destination is to occur. Although illustrated as being provided as part of memory 28 which also contains filtering module 32 and selection module 34, in other implementations, service provider database 30 may alternatively be remotely stored and remotely maintained (separate from module 32 and 34 and remote from processor 26), wherein processor 26 may access database 30 at the remote location through a network connection.

Filtering module 32 and selection module 34 each comprise computer readable program or code stored in memory 28 and configured to direct processor 26 to carry out the process or method 100 shown in FIG. 2. As indicated by step 102, processor 32, following instructions contained in filtering module 32, directs or instructs processor 28 to initially obtain or identify the service destination (SD). As noted above, the final service destination may be input directly as part of the service request or may be determined by processor 26 based upon information associated with a service request. In some implementations, a service request may be automatically generated by a monitoring system that monitors a population of potential final service destinations, wherein the service request is automatically generated and transmitted to system 20 when the electronic or automated monitoring system determines that service should be performed, such as when an issue or alert arises or such as when a precautionary measure should be taken to avoid a predicted impending problem.

As indicated by step 104 in FIG. 2, following instructions contained in filtering module 32, processor 26 filters the service provider population contained in service provider population database 30 based upon a geographic zone about or containing the service destination. Processor 26 identifies a subset of possible service providers (candidate service providers) from the overall service provider population for further analysis. In particular, processor 26 compares the boundaries of the geographic zone with a current location or starting point for each service provider (obtained from database 30) and eliminates or culls out those service providers who do not have current locations within the geographic zone.

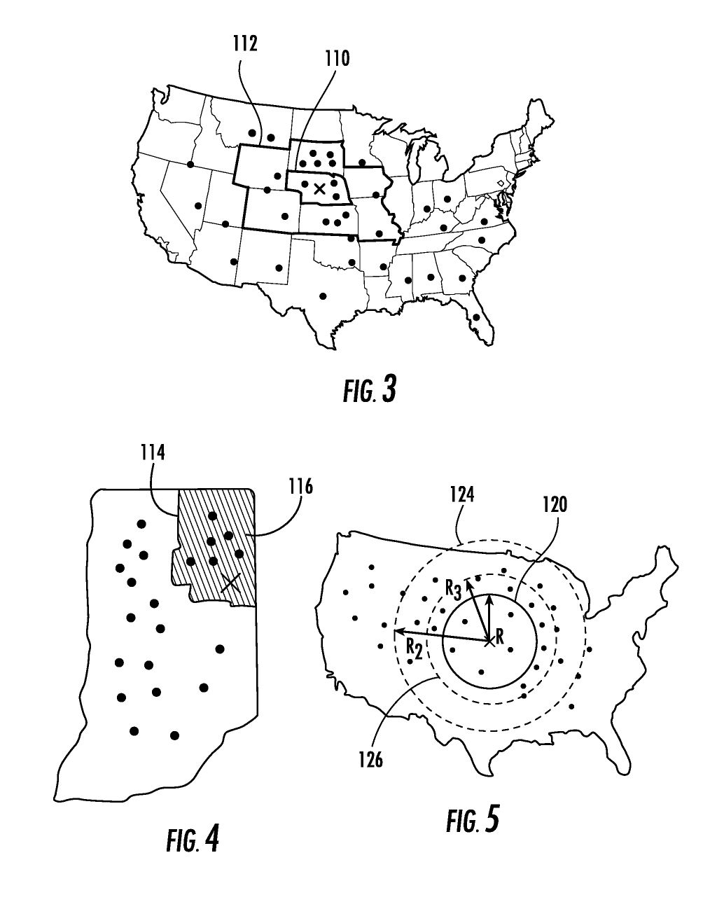

FIGS. 3-5 illustrate various examples of geo-zone filtering of service providers that may be carried out by processor 26 following instructions in filtering module 32. In each of the examples, the “X” identifies the target service destination while each “.” represents a starting location of a service provider. Although particular geographic regions are illustrated in such examples, it should be understood that the principles of such examples could equally apply to other geographic regions of different sizes and at different locations throughout the world.

In the example shown in FIG. 3, filtering module 32 defines a geographic zone containing the target destination using one or more predefined geographic boundaries. In one example, as indicated by the thicker lines 110, filtering module 32 may define a geographic zone using a state boundary (in this case, the state boundary lines for Nebraska where the service destination is also located in Nebraska). In other instances, filtering module 32 may define the geographic zone as the outermost boundary of a collection of states, such as indicated by the multistate region outlined by line 112. In still other implementations, filtering module 32 may use other predefined geographic boundaries, such as an individual or a set of country boundaries, an individual or set of county boundaries or individual or set of other government or other defined geographic boundaries.

In the example shown in FIG. 4, filtering module 32 defines a geographic zone using an individual or a set of zip code boundaries. In the example shown, the boundaries 114 of a zip code zone 116 is set by module 32 as the geographic zone (in this case, a zip code zone or region in the state of Indiana). In other implementations, the outermost boundaries of a collection of adjacent zip code zones may be utilized as the geographic zone for filtering the service provider population in step 104 in FIG. 2.

In the example shown FIG. 5, filtering module 32 defines a geographic zone 120 as a circular zone centered about the service destination X and having a radius R. In particular, filtering module 32 directs processor 26 to determine the boundaries of zone 120 using spherical trigonometry. In one implementation, geographic zone 120 is determined using a Haversine formula to identify those service provider starting locations “.” which are located within a predetermined radius R from service destination X. In such an implementation, both the service provider starting location and the service destination are defined with a latitude and longitude based upon the address of the service destination. Use of such spherical trigonometry determines a straight-line distance (as the crow flies distance) between the service provider starting point and the service destination. Because processor 26 defines zone 120 using spherical trigonometry or the Haversine formula, the boundaries of zone 120 are not restricted to any artificial boundary such as a county or state line or the boundary of a zip code. As a result, a zone may be established such that service destination is reliably a center point of the zone, equidistant from all boundaries of the zone. Consequently, the filtering of possible service providers is enhanced.

In some implementations, a combination of different types of geographic zones may be utilized to filter the overall population of service providers contained in service provider database 30. For example, in one implementation, the population a service provider 30 may be initially filtered to exclude those service providers not within a particular geographic zone, such as an individual or set of states boundary (using the filtering exemplified in FIG. 3) or a predefined region (for example, predefined boundaries about the “Midwest”). Following this initial filtering, under the direction of filtering module 32, processor 26 may carry out an additional filtering step, further excluding those service providers not within a predefined radius from the service destination using spherical trigonometry (using the filtering exemplified in FIG. 5).

As indicated by step 106, once the larger population of service providers contained in database 30 has been filtered down to a smaller group of candidate service providers having starting locations within the geographic zone, processor 26, following instructions contained in selection module 34, compares travel times for each of the candidate service providers (in-zone service providers) to select an individual service provider for servicing the service destination. For purposes of this disclosure, the term travel times means the estimated time for an individual service provided to travel from an associated starting location to the service destination. In one implementation, this estimated time may be based upon factors such as route distance, route characteristics and traffic patterns. Route distance refers to the distance of an actual route. For example, an actual route to go from a starting point to a service destination may not be a straight line, but may involve multiple twists and turns which may impact travel time.

Route characteristics refers to characteristics of the travel route between a service provider starting point and the service destination. For example, travel along interstate may have a lower travel time for a given distance as compared to travel along a city street with stoplights or tolls. Travel along a route undergoing road construction may consume more time for the given distance.

Traffic patterns refers to temporary factors relating to traffic or congestion that impact a rate of travel along a given travel route. For example, travel on a particular route during a particular time of the day, during a particular day of the week, during a particular holiday or during a particular event (traffic just prior to or after a sporting event) may encounter traffic congestion that may impact the amount of time consumed while traveling on the particular route. Different modes of travel, and their associated costs, may also be factored into the travel time comparison by processor 26 under the direction of selection module 34. In one implementation, the individual candidate service provider having the shortest travel time is selected by processor 26 for servicing the service destination.

In one implementation, the travel times utilized by processor 26 to evaluate the candidate in-zone service providers may be stored in a memory local to processor 26, such as indicated by travel time database 38. Such a travel time database may be updated periodically taking into account changes, such as changes in available travel routes, changes in construction status or changes in traffic patterns. In another implementation, such a travel time database 38 may be stored and maintained at a travel time source 40 which is at a location remote from processor 26 and remote from system 20, wherein the travel time source 40 is accessed through a network, such as the Internet. In one implementation, the travel time source 40 may be provided by a third-party commercial vendor such as MAPQUEST or GOOGLE MAPS.

According to one implementation, the travel times being compared by processor 26 to select a service provider from the candidate in-zone service providers may be based upon multiple factors such as the above-described route distance, route characteristics and traffic patterns. In other implementations, other factors or a fewer number of such factors may be utilized. For example, in one implementation, the travel times used for such comparisons may be based solely on route distance.

As indicated by step 108, once a service provider is selected, the selected service provider is dispatched to the service destination using output 24. As noted above, in one implementation, the selected service provider may be displayed on a monitor or screen, wherein a coordinator will contact and assign a selected service provider to the task. In another implementation, this assignment may be automated, wherein the selected service provider is electronically notified in some fashion of the service request and his or her assignment to the service request.

Overall, because system 20 selects a service provider in a multi-step approach wherein the larger population of service providers is first filtered or culled based upon whether each service provider is within a predefined geographic boundary or is within a straight line distance or radius from the service destination prior to the generally more time-consuming and tedious travel time comparison using specific “street-level routes”, the processing power and processing time utilized to select the service provider is reduced. In other words, rather than carrying out specific street level route calculations for each and every service provider, processor 26 just carries out such calculations and comparisons for an already filtered subset of service providers. As a result, a service provider may be more quickly selected and a service provider may be more quickly dispatched, increasing the likelihood that the emergency service will be completed in a timely fashion.

In some implementations, a service task may involve one or more intermediate service destinations between the service provider starting point and the final service destination. For example, a repair task may involve a service provider initially picking up or obtaining a part, tool or information from the intermediate service destination before proceeding to the final service destination. In circumstances where each service provider would have to travel to the same intermediate service destination prior to traveling from intermediate destination to the final service destination, the geo zone utilizing step 104 may alternatively be established so as to contain the intermediate destination, wherein the service provider selected by system 20 would be based upon travel times to the intermediate service destination. For example, when the zone is defined as a straight line distance using spherical trigonometry, the radius of the geo zone would be centered at the intermediate destination. In other circumstances where the intermediate service destination (part, tool or information pickup point) is different for each service provider, the final service destination may serve as a center of the geo-zone or may be used to define the geo-zone for geo-zone filtering in step 104, wherein selection module 34 may compare travel times for the different routes for each in-zone service provider from his or her starting point to his or her particular intermediate service destination and finally from the particular intermediate service destination to the service destination when selecting a service provider.

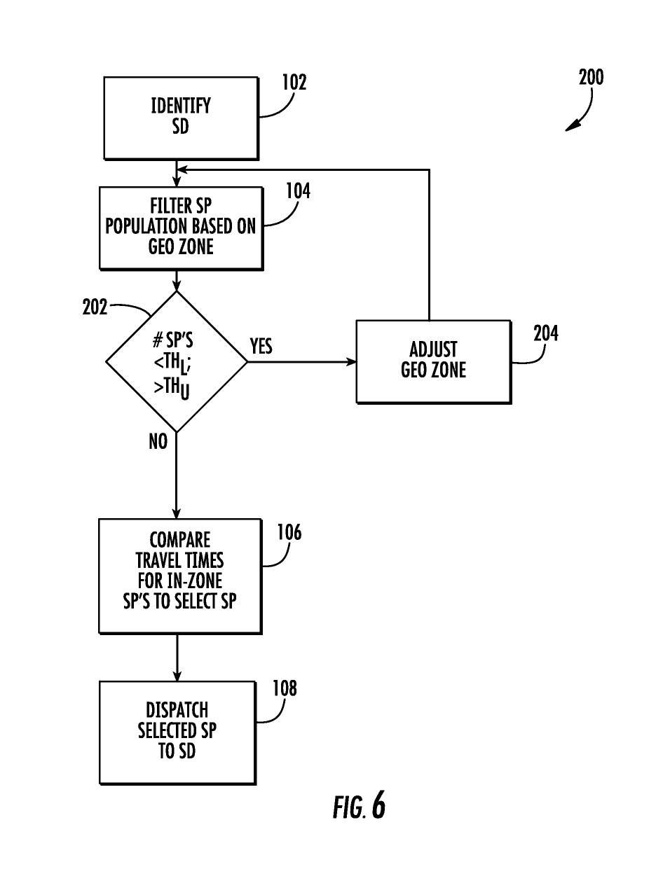

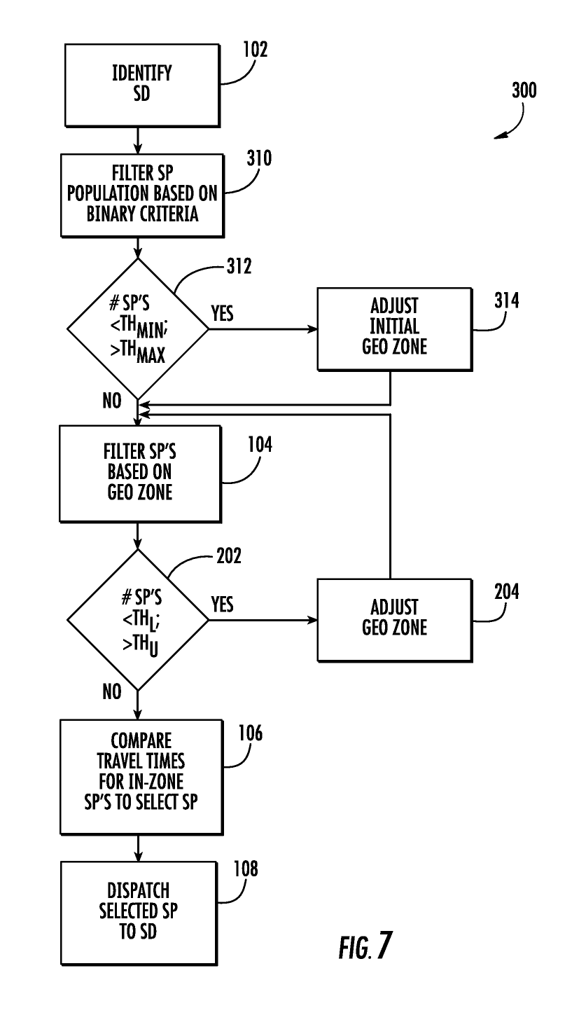

FIG. 6 is a flow diagram of method 200, an example implementation of method 100 that may be carried out by system 20 (shown in FIG. 1). For ease of discussion, those steps of method 200 which correspond to steps of method 100 are numbered similarly. As shown by FIG. 6, method 200 is similar to method 100 except that method 200 additionally includes steps 202 and 204.

As indicated by step 202, once the full service provider population, as defined in service provider database 30, has been filtered to remove those service providers that are not within a geo-zone from the list of possible candidate service providers, processor 26 (following instructions contained in filtering module 32) evaluates the size of the remaining candidate service providers. Processor 26 evaluates the number of in-zone service providers to at least one of a lower predefined threshold TH_{L} and an upper predefined threshold TH_{U}. Based on this comparison, processor 26 either proceeds with the comparison of travel time and the selection of a service provider per step 106 under the direction of selection module 34 or proceeds to step 204 in which a size of the geo-zone is adjusted. If the size of the geo-zone is adjusted, processor 26 repeats step 104, but filters the entire population using the adjusted geo-zone. As a result, the size of the list of candidate service providers (in-zone service providers) is controlled—not too small such that the pool of candidate service providers being compared in step 106 is insufficient to produce a satisfactory result and not too large such that the processing time for carrying out step 106 is burdensome.

FIG. 5 illustrates an example of the adjustment of a size of the geographic zone (geo-zone) depending upon the predefined target range for the number of service providers to compare in step 106. In the example shown in FIG. 5, the initial filtering in step 104 may yield a number of in-zone service providers that is less than a predefined lower threshold TH_{L}. As a result, the size of the geo-zone may be increased. In the example illustrated in which the zone is defined by a straight line distance using spherical trigonometry, the size of the initial zone 120 is increased by increasing the radius of the zone from R to R₂ to form the larger zone 124 containing a larger number of candidate service providers available for evaluation in step 106.

After the size of the zone has been increased, step 202 is repeated. If the number of in-zone service providers is still less than the lower threshold TH_{L}, the size of the zone may be further increased, with this process repeated until the lower threshold TH_{L} has been satisfied. Alternatively, if the number of in-zone service providers is greater than the upper threshold TH_{U}, the size of the zone may be adjusted downwardly or reduced. In the example shown in FIG. 5, if the number of service providers in-zone 124 exceeds the upper threshold TH_{U}, the size of the geo-zone 124 may be reduced to zone 126 having a radius R₃ greater than the initial radius R, but less than the enlarged radius R₂. In such a manner, processor 26 iteratively determines an appropriate size for the geo-zone so as to yield an appropriate number of service providers for evaluation in step 106.

In one implementation, the extent or rate at which processor 26 adjusts the size of the zone may also vary based upon an evaluation by processor 26. For example, in one implementation, processor 26 may evaluate the extent to which the number of in-zone service providers falls below the lower threshold TH_{L} or exceeds the upper threshold TH_{U}. In either case, if the extent is large (greater than a secondary predefined threshold stored in memory 28), processor 26 may increase or decrease the size of the zone by a corresponding larger extent in step 204. Likewise, if the extent is small (less than a secondary predefined threshold stored in memory 28), processor 26 may increase or decrease the size of the zone by a corresponding lesser extent in step 204. In some implementations, processor 26 may apply different size adjustment rates or size adjustment rate criteria for when the upper threshold THU is exceeded as compared to when the lower threshold TH_{L} is not satisfied.

In other implementations, rather than making such bidirectional geo-zone size adjustments, processor 26 may alternatively make unidirectional geo-zone size adjustments. For example, the initial or default size of the geo-zone used by processor 26 (the radius R in the example of FIG. 5) in the initial filtering carried out in step 104 may be set at a minimum size, wherein the size of the zone is incrementally increased until the lower threshold TH_{L} for the number of in-zone service providers is satisfied.

Likewise, such unidirectional geo-zone size adjustments may also occur in the opposite direction. The initial size of the geo-zone used by processor 26 (the radius R in spherical trigonometry) may set at a predefined maximum default size, wherein the size of the zone is incrementally decreased until the upper threshold TH_{U} for the number of in-zone service providers is no longer being exceeded.

FIG. 7 is a flow diagram of method 300, another example implementation of method 100 that may be carried out by system 20 (shown in FIG. 1). Method 300 is similar to method 200 except that method 300 additionally includes steps 310, 312 and 314. For ease of discussion, those steps of method 300 which correspond to steps of method 200 are numbered similarly.

As indicated by step 310, prior to carrying out the geo-zone filtering of step 104, processor 26, following instructions contained in filtering module 32, performs an initial filtering step wherein the full population of service providers, as defined in service provider database 30, is filtered based upon at least one binary criteria. For purposes of this disclosure, a “binary criteria” refers to a qualitative evaluation which produces either a yes or no result. In the example, processor 26 carries out any binary criteria filtering steps using service provider information or data found in database 30. Those service providers not satisfying a binary criteria filtering step are filtered out, removed from the set of service providers passed on to step 104 for geo-zone filtering.

In one implementation, processor 26 carries out filtering using information within service provider database 30 such as service provider certifications (any degrees are training certifications acquired by the service provider such as a Microsoft Certification), service provider skill levels (what machines, devices, software, etc. for which the service provider has experience or training), service provider languages (what language a service provider is fluent in such as English, Spanish, German, Chinese), service provider security clearances (any security clearances already obtained from selected clients), and service provider availability.

For example, service provider 26 may cull or remove from further potential consideration all service providers not having a particular certification level. Service provider 26 may remove from further potential consideration all service providers not having a particular skill level. Service provider 26 may remove further potential consideration all service providers not fluent in a particular language. Service provider 26 may remove from further potential consideration all service providers who are not available during a particular time period. What particular criteria are applied by processor 26 may vary depending upon the characteristics of the particular service request such as the type of service to be provided or the particular service requester's preferences. In other implementations, other criteria may be applied in step 310.

As indicated by steps 312 and 314, processor 26 evaluates the remaining number of service providers left after such binary filtering and may adjust the initial size of the geo-zone filter to be applied in step 104 based on this evaluation. As indicated by step 312, processor evaluates the number of remaining service providers to at least one of a lower predefined threshold TH_{MIN} and an upper predefined threshold TH_{MAX}. Based on this comparison, processor 26 either proceeds with the geo-zone filtering in step 104 with a predefined or default initial geo-zone size (radius R in spherical trigonometry) or proceeds to step 314 in which a size of the initial geo-zone is adjusted prior to carrying out the geo-zone filtering of step 104. As a result, with method 300, processor 26 may more quickly arrive at an appropriate geo-zone size for filtering, reducing the time consumed during the iterative process of steps 104, 202 and 204.

By way of example, if the binary filtering carried out in step 310 yields a number of service providers that is less than a predefined lower threshold TH_{MIN}, processor 26 may increase the size of the initial geo-zone. Alternatively, if the number of remaining service providers after step 310 is greater than the upper threshold TH_{MAX}, the size of the initial geo-zone may be adjusted downwardly or reduced.

In one implementation, the extent or rate at which processor 26 adjusts the size of the initial geo-zone may also vary based upon an evaluation by processor 26. For example, in one implementation, processor 26 may evaluate the extent to which the number of remaining service providers falls below the lower threshold TH_{MIN} or exceeds the upper threshold TH_{MAX}. In either case, if the extent is large (greater than a secondary predefined threshold stored in memory 28), processor 26 may increase or decrease the initial default size of the geo-zone by a corresponding larger extent in step 314. Likewise, if the extent is small (less than a secondary predefined threshold stored in memory 28), processor 26 may increase or decrease the size of the initial geo-zone by a corresponding lesser extent in step three and 14. In some implementations, processor 26 may apply different size adjustment rates or size adjustment rate criteria for when the upper threshold TH_{MAX} is exceeded as compared to when the lower threshold TH_{MIN} is not satisfied. Although processor 26 determines whether the remaining number of service providers falls within a predefined range to determine whether the initial or default geo-zone should be adjusted in step 314, in other implementations, processor 26 may alternatively compare the remaining number of service providers to one of the lower threshold TH_{MIN} or the upper threshold TH_{MAX}, rather than a range, to determine whether the initial geo-zone size should be adjusted in step 314. In some implementations, steps 312 and 314 may be omitted. In step 104, processor 26 carries out the geo-zone filtering operation on the remaining service providers rather than the overall service provider population set forth in database 30.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

1. A computer-implemented method comprising:
receiving a service destination;
filtering a population of service providers to identify candidate service providers, the filtering being based upon whether each server provider has a starting location within a geographic zone containing the service destination;
comparing travel times to the destination for the candidate service providers;
selecting a service provider from the candidate service providers based on the comparison; and
dispatching the selected service provider to the destination.

2. The method of claim 1 further comprising determining the geographic zone using spherical trigonometry, wherein the geographic zone is an area having a radius centered at the destination.

3. The method of claim 2 further comprising adjusting the radius of the area of the geographic zone if a number of the candidate service providers does not satisfy a predetermined threshold.

4. The method of claim 2, wherein the filtering comprises applying a binary criteria to the population of service providers prior to determining the geographic zone.

5. The method of claim 4 further comprising enlarging the radius of the area of the geographic zone if a number of candidate service providers, following the filtering with the binary filtering criteria and prior to filtering with the geographic zone, is less than a predefined threshold.

6. The method of claim 1, wherein the filtering is further based on a group of binary filtering criteria consisting of: service provider skill; service provider language; service provider security clearance; service provider certification; and service provider availability.

7. The method of claim 1 further comprising adjusting the geographic zone if a number of the candidate service providers does not satisfy a predetermined threshold.

8. The method of claim 1, wherein the travel times are based on factors comprising traffic patterns and travel route characteristics.

9. The method of claim 1, wherein the geographic zone is selected from a group of geographic zones consisting of a zip code and a geographic boundary.

10. An apparatus comprising:
an input to receive a service destination;
a memory storing a population of service providers;
a filtering module to filter the population of service providers to identify candidate service providers, the filtering being based upon whether each server provider has a starting location within a geographic zone containing the service destination;
a selection module to select a service provider by comparing travel times to the destination for the candidate service providers; and
an output to identify the selected service provider.

11. The apparatus of claim 10, wherein the memory stores data for each of the service providers in the population, the data selected from a group of data consisting of: service provider skill; service provider language; service provider security clearance; service provider certification; and service provider availability; and
wherein the filtering module filters the population of service providers based upon the data.

12. The apparatus of claim 10, wherein the filtering module is further configured to adjust the radius of the area of the geographic zone if a number of candidate service providers, following the filtering with the data and prior to filtering with the geographic zone, does not satisfy a predetermined threshold.

13. The apparatus of claim 10, wherein the filtering module is configured to further determine the geographic zone using spherical trigonometry, wherein the geographic zone is an area having a radius centered at the destination.

14. The apparatus of claim 13, wherein the filtering module is configured to adjust the radius of the area of the geographical zone if a number of the candidate service providers does not satisfy a predetermined threshold.

15. An apparatus comprising:
a non-transient computer-readable medium containing instructions configured to direct a processor to:
receive a service destination;
determining a number of candidate service providers within a geographic zone having a radius centered at the destination;
incrementally increasing the radius of the geographic zone until the number of candidate service providers within the geographic zone satisfies a predetermined threshold;
compare travel times to the destination for the candidate service providers within the geographic zone; and
select a service provider from the candidate service providers based on the comparison.

16. The method of claim 1, wherein the service destination is received by a processor which performs the filtering of the population of service providers to identify candidate service providers, the comparing of travel times for the candidate service providers and the selecting of the service provider.

17. The apparatus of claim 10, wherein the input comprises a device by which information is received.

18. The apparatus of claim 15, the geographic zone is determined using spherical trigonometry, wherein the geographic zone is an area having a radius centered at the destination.

19. The apparatus of claim 18, wherein the instructions are further configured to direct the processor to adjust the radius of the area of the geographic zone if a number of the candidate service providers does not satisfy a predetermined threshold.

20. The apparatus of claim 18, wherein the filtering comprises applying a binary criteria to the population of service providers prior to determining the geographic zone.

21. The apparatus of claim 20, wherein the instructions are further configured to direct the processor to enlarge the radius of the area of the geographic zone if a number of candidate service providers, following the filtering with the binary filtering criteria and prior to filtering with the geographic zone, is less than a predefined threshold.
